(19) United States
(12) Patent Application Publication
(10) Pub. No.: US 2025/0254096 A1
(43) Pub. Date: Aug. 7, 2025

(54) NODE MANAGEMENT METHOD USING VIRTUAL NODE

(71) Applicant: SAMSUNG ELECTRONICS CO., LTD., Suwon-si (KR)

(72) Inventor: Jonggyu HAM, Suwon-si (KR)

(73) Assignee: SAMSUNG ELECTRONICS CO., LTD., Suwon-si (KR)

(21) Appl. No.: 19/185,917

(22) Filed: Apr. 22, 2025

Related U.S. Application Data
(63) Continuation of application No. PCT/KR2023/016320, filed on Oct. 20, 2023.

(30) Foreign Application Priority Data
Oct. 27, 2022 (KR) 10-2022-0140716
Jan. 16, 2023 (KR) 10-2023-0006316

(51) Int. Cl. H04L 41/122; H04L 41/0895; H04L 41/12

(52) U.S. Cl. CPC H04L 41/122; H04L 41/0895; H04L 41/12

(57) ABSTRACT

A method of performing communication by a virtual node includes receiving a registration request from at least one node of a plurality of nodes, performing registration of the at least one node, based on information related to the at least one node, receiving, from a control plane, a pod indicating at least one distributable computing unit of a task to be completed, identifying a first node from among the at least one node to which the pod is to be transmitted, based on the information related to the at least one node, and transmitting the pod to the first node. The plurality of nodes and the virtual node are controlled by the control plane.

### CROSS-REFERENCE TO RELATED APPLICATIONS

This application is a continuation application of International Application No. PCT/KR2023/016320, filed on Oct. 20, 2023, which claims priority to Korean Patent Application No. 10-2022-0140716, filed on Oct. 27, 2022, and Korean Patent Application No. 10-2023-0006316, filed on Jan. 16, 2023, in the Korean Intellectual Property Office, the disclosures of which are incorporated by reference herein in their entireties.

### BACKGROUND

### 1. Field

The present disclosure relates generally to cluster computing, and more particularly, to a method of registering and managing at least one node by using a virtual node.

### 2. Description of Related Art

Recent advancements in computing technology may include the emergence of cluster computing technology in which a plurality of computers and/or groups of applications may operate for a common goal rather than a single computer performing multiple distinct operations. That is, cluster computing may perform tasks together by integrating and/or coordinating a plurality of machines, which may include a master node and a plurality of nodes to perform the tasks.

For example, nodes within an existing cluster may include static nodes that may have little to no mobility, and as such, may perform tasks without significant changes in available resources. As another example, a cluster system that may need a relatively high level of security may be implemented as an on-premise system, and may be restricted from using an external cloud. As another example, a cluster may be configured to include mobile nodes to ensure resource mobility. However, a cluster may be poorly configured for nodes (e.g., mobile nodes) with a significant amount of fluctuation in a network state due to changes in resources, batteries, mobility, or the like.

Thus, there exists a need for further improvements in cluster computing technology, as the need for controlling nodes within a cluster may be constrained by poor configurations that may not account for resource demands of the nodes within the cluster. Improvements are presented herein. These improvements may also be applicable to other computing technologies.

### SUMMARY

According to an aspect of the present disclosure, a method of performing communication by a virtual node includes receiving a registration request from at least one node of a plurality of nodes, performing registration of the at least one node, based on information related to the at least one node, identifying a first node from among the at least one node to which a pod received from a control plane is to be transmitted, based on the information related to the at least one node, and transmitting the pod to the first node. The plurality of nodes and the virtual node are controlled by the control plane.

According to an aspect of the present disclosure, a method of performing communication by a node includes obtaining, from a control plane, information related to a virtual node, transmitting, to the virtual node, a registration request including information related to the node, based on the information related to the virtual node, and receiving, from the virtual node, at least one pod, based on registration information generated based on the registration request. The pod indicates at least one distributable computing unit of a task to be completed. The control plane controls the virtual node and a plurality of nodes including the node.

According to an aspect of the present disclosure, a virtual node for performing communication includes a transceiver, one or more processors including processing circuitry, and memory storing one or more instructions. The one or more instructions, when executed by the one or more processors individually or collectively, cause the virtual node to receive a registration request from at least one node of a plurality of nodes, perform registration of the at least one node, based on information related to the at least one node, identify a first node from among the at least one node to which a pod received from a control plane is to be transmitted, based on the information related to the at least one node, and transmit the pod to the first node. The plurality of nodes and the virtual node are controlled by the control plane.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a diagram for explaining a node management method, according to an embodiment of the present disclosure;

FIG. 2 is a diagram for explaining a node management method through a virtual node, according to an embodiment of the present disclosure;

FIG. 3 is a diagram for explaining an operation of a virtual node, according to an embodiment of the present disclosure;

FIG. 4 is a schematic block diagram of a virtual node, according to an embodiment of the present disclosure;

FIG. 5 is a flowchart for explaining a node management method through a virtual node, according to an embodiment of the present disclosure;

FIG. 6 is a flowchart for explaining a procedure for registration to a virtual node, according to an embodiment of the present disclosure;

FIG. 7 is a flowchart for explaining a distribution procedure of a pod, according to an embodiment of the present disclosure;

FIG. 8 is a diagram for explaining a rearrangement procedure of a pod, according to an embodiment of the present disclosure;

FIG. 9 is a flowchart for explaining an example of a node management method through a virtual node, according to an embodiment of the present disclosure; and

FIG. 10 is a flowchart for explaining an example of a node management method through a virtual node, according to an embodiment of the present disclosure.

### DETAILED DESCRIPTION

The present disclosure may have various modifications and embodiments, and thus certain embodiments are illustrated in the drawings and described through the detailed description. However, the described embodiments are not intended to limit the embodiments of the present disclosure, and it is to be understood that the present disclosure includes all modifications, equivalents, and alternatives included in the spirit and technical scope of the various embodiments.

In describing the embodiments, if it is determined that a detailed description of a related known technology may unnecessarily obscure the gist of the present disclosure, the detailed description may be omitted. Numbers used in the description of the present disclosure (e.g., “first”, “second”, or “third”) are merely identifiers to distinguish one component from another, and may not limit the components in other aspects (e.g., importance or order). For example, the terms “first”, “second”, “third”, or the like may not necessarily involve an order or a numerical meaning of any form.

The terms used in the embodiments of the present disclosure may be selected from commonly used terms as much as possible while considering the functions of the present disclosure, but these may vary depending on the intention of a technician working in the field, precedents, the emergence of new technologies, or the like. In certain cases, there are terms arbitrarily selected by the applicant, and in this case, the meanings of the terms may be described in the description of the corresponding embodiment. Therefore, the terms used in the present disclosure may be defined based on the meaning of the terms and the overall contents of the present disclosure, rather than simply the names of the terms.

The scope of the present disclosure may be indicated by the claims below rather than by the detailed description. Various features mentioned in one claim category of the present disclosure (e.g., in a method claim) may also be claimed in another claim category (e.g., in a system claim). An embodiment of the present disclosure may include not only combinations of features specified in the appended claims, but also various combinations of individual features within the claims. The scope of the present disclosure may be interpreted to include all changes or modifications derived from the meaning and scope of the claims and their equivalent concepts within the scope of the present disclosure.

Components expressed as ‘˜unit’ or ‘module’ in the present disclosure may be two or more components combined into one component, or one component may be divided into two or more components according to more detailed functions. These functions may be implemented in hardware, software, and/or a combination of hardware and software. Each component described below may additionally perform some or all of the functions performed by other components in addition to its own main function, and some of the main functions performed by each component may be performed exclusively by other components.

A singular expression may include a plural expression unless the context clearly indicates otherwise. Terms used herein, including technical or scientific terms, may have the same meaning as commonly understood by those of skill in the art described herein.

Throughout the present disclosure, unless specifically stated otherwise, “or” is inclusive and not exclusive. Thus, unless explicitly indicated otherwise or the context indicates otherwise, “A or B” may mean “A, B, or both.” In the present disclosure, the phrases “at least one of ˜” or “one or more ˜” may mean that different combinations of one or more of the listed items may be used, or that only any one of the listed items is required. For example, “at least one of A, B, and C” may include any of the following combinations: A, B, C, A and B, A and C, B and C, or A, B and C.

It is to be understood that each block of processing flowcharts and combinations of the flowcharts may be performed based on computer program instructions. These computer program instructions may be installed in a processor of a general-purpose computer, a special-purpose computer, or other programmable data processing apparatus, and thus the instructions executed by the processor of the computer or other programmable data processing apparatus generate an element for performing the functions described in the flowchart blocks. These computer program instructions may also be stored in a computer-available or computer-readable memory that may direct a computer or other programmable data processing device to implement a function in a certain manner, and thus the instructions stored in the computer-available or computer-readable memory may also produce an article of manufacture that includes an instruction element for performing the function described in the flowchart blocks. The computer program instructions may be installed in a computer or other programmable data processing apparatus, and thus a series of operations may be performed on the computer or other programmable data processing apparatus to generate a process executed by a computer, and the instructions executing the computer or other programmable data processing apparatus may also provide operations for executing the functions described in the flowchart blocks.

Each block may represent a module, segment, or portion of code that contains one or more executable instructions for performing a particular logical functions. It is noted that in some alternatives, it may be possible for the functions mentioned in the blocks to occur out of order. For example, two blocks shown in succession may in fact be executed substantially simultaneously, or the blocks may sometimes be executed in reverse order, depending on their respective functions.

A function related to artificial intelligence, according to the present disclosure, may be operated through a processor and memory. The processor may include one or more processors. The one or more processors may be and/or may include a general-purpose processor (e.g., a central processing unit (CPU), an application processor (AP), or a digital signal processor (DSP)), a graphics-only processor (e.g., a graphics-processing unit (GPU) or a vision processing unit (VPU)), or an artificial intelligence-only processor (e.g., a neural processing unit (NPU)). The one or more processors may be controlled to process input data according to a predefined operation rule and/or artificial intelligence (AI) model stored in memory. Alternatively, if the one or more processors are AI-specific processors, the AI-specific processors may be designed with a hardware structure specialized for processing a particular AI model.

The predefined operation rule or AI model may be made through learning. As used herein, being made through learning may refer to a basic AI model being learned (trained) by using a relatively large amount of learning data, based on a learning algorithm, thereby making a predefined operation rule or AI model configured to perform a desired characteristic (or purpose). Such learning may be performed on a device itself on which AI, according to the present disclosure, may be performed, and/or may be performed through a separate server and/or system. Examples of learning algorithms may include, but may not be limited to, supervised learning, unsupervised learning, semi-supervised learning, reinforcement learning, or the like.

An AI model may include a plurality of neural network layers. The plurality of neural network layers may have a plurality of weight values, respectively, and may perform a neural network operation through an operation between the operation result of a previous layer and the plurality of weight values. The plurality of weight values of the plurality of neural network layers may be optimized according to the learning result of the AI model. For example, the plurality of weight values may be updated such that a loss value and/or cost value obtained from the AI model may be reduced and/or minimized during a learning procedure. An artificial neural network may include a deep neural network (DNN), for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or deep Q-networks. However, the present disclosure is not limited to the examples described above.

Hereinafter, embodiments of the present disclosure are described with reference to the accompanying drawings such that those of skill in the art to which the present disclosure pertains may easily implement the present disclosure. However, the present disclosure may be implemented in many different forms and is not limited to the embodiments described herein. To explain the present disclosure in the drawings, portions that are not related to the explanation may be omitted, and similar portions may be given similar drawing reference numerals throughout the present disclosure.

The terms used in the present disclosure are briefly described, and an embodiment of the present disclosure is described in detail.

The terms described below are terms defined in consideration of functions in the present disclosure and may vary depending on the intention or custom of a user or operator. Therefore, the definition may be based on the contents throughout the present disclosure.

As used herein, a cluster may refer to a group of nodes operating for a common goal.

In the present disclosure, a node may be and/or may include a single server included in a cluster and may refer to a computing engine unit.

As used herein, a pod may refer to a smallest distributable computing unit that may be generated and/or managed in a cluster.

In the present disclosure, a container may refer to part or all of an application.

As used herein, a control plane may refer to a node that manages operations within a cluster and may also be referred to as a master node or as a master server.

In the present disclosure, a universally unique identifier (UUID) may refer to a unique identifier assigned to a node.

Hereinafter, various embodiments of the present disclosure are described with reference to the accompanying drawings.

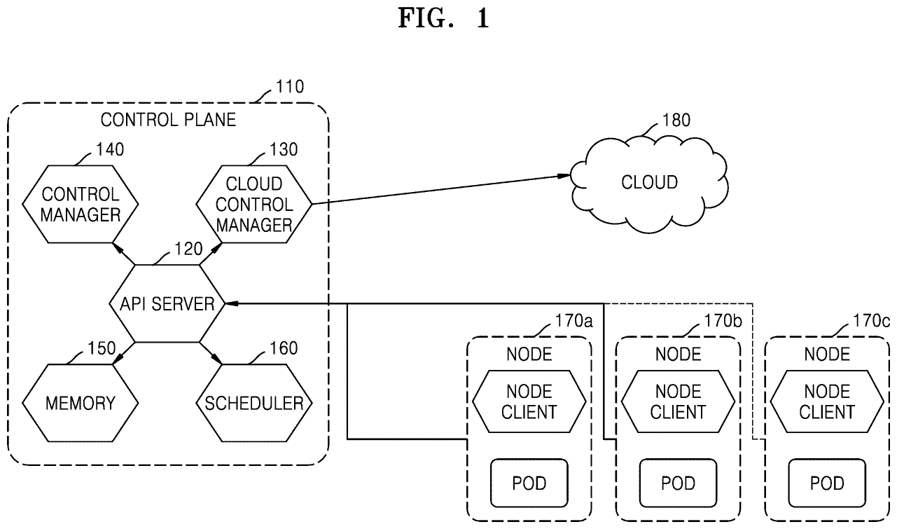

FIG. 1 is a diagram for explaining a node management method, according to an embodiment of the present disclosure.

Referring to FIG. 1, a control plane 110 may include, but is not limited to, an application programming interface (API) server 120, a cloud control manager 130, a control manager 140, memory 150, and a scheduler 160. A plurality of nodes (e.g., a first node 170a, a second node 170b, and a third node 170c) may include a node client and may receive a pod from the control plane 110. As used herein, the control plane 110 may be referred to as a master server and/or a master node. The control plane 110 may transmit and/or receive data to and/or from an external cloud 180.

The control plane 110 may obtain information about the plurality of first to third nodes 170a to 170c through virtualization-based clustering and manage the plurality of first to third nodes 170a to 170c, based on the obtained information. As used herein, clustering may refer to an operation of connecting a plurality of systems connected to a network to operate as a single system to process a high-performance task and/or a large-scale task. As an example of virtualization clustering, the control plane 110 may manage the plurality of first to third nodes 170a to 170c through a clustering system, such as, but not limited to, a Linux Kubernetes® management system. The Linux Kubernetes® may be an open source platform for managing a containerized workload and a service.

The control plane 110 may determine the overall operation of a cluster and may detect and react to an event occurring within the cluster. The API server 120 of the control plane 110 may play a central role in a virtualization cluster. The API server 120 may provide an interface at a server side such that a client may request a resource. The A PI server 120 may serve as a central access point to monitor each element (e.g., a node or a pod) of the cluster and perform a task. For example, the control plane 110 may interact with and exchange data with the plurality of first to third nodes 170a to 170c through the API server 120.

In an embodiment, the API server 120 may perform various functions within the cluster, such as, but not limited to, user authentication, request validation, data reception, memory update, and scheduling.

In an embodiment, the plurality of first to third nodes 170a to 170c may obtain information about a virtual node 10 from the API server 120. The plurality of first to third nodes 170a to 170c may determine whether connection to the virtual node 10 is possible based on the obtained information about the virtual node 10. In an embodiment of the present disclosure, the information about the virtual node 10 may include, but is not limited to, a connection method to the virtual node 10, a connection address (e.g., an Internet Protocol (IP) address), or the like.

The cloud control manager 130 of the control plane 110 may be a component that may include control logic for each external cloud 180. The cloud control manager 130 may connect the cluster to the external cloud 180 and may perform addition and/or deletion of a node.

The control manager 140 of the control plane 110 may manage a state of an object within the virtualization cluster. The control manager 140 may include, but is not limited to, a node controller for managing a node, a job controller for generating a pod for a one-time task until the corresponding task is completed, an endpoint controller for connecting a service to the pod, and a token controller for generating an A PI access token. The control manager 140 may be and/or may include a processor that may monitor various resources driven within the cluster and may manage the resources to perform an operation.

The memory 150 of the control plane 110 may store all data of the cluster. The memory 150 may refer to a distributed data storage, for example, Linux etcd®. However, the present disclosure is not limited in this regard. The memory 150 may store and manage information about the state of an object. The distributed data storage may store information about each component within the cluster in the form of key-value to be distributed and stored and may replicate and store the corresponding value in a distributed manner. For example, data stored in the memory 150 may include information about the number of nodes in the cluster, available memory for each node, a pod managed by each node, containers provided in respective pods, or the like.

The scheduler 160 of the control plane 110 may select a node on which the generated pod is to be executed. The scheduler 160 may determine a node on which a pod is to be placed in consideration of an available resource of a node, a current resource state, or the like. For example, the scheduler 160 may arrange pods on nodes, based on a computing resource (e.g., CPU, memory, or the like) required by a plurality of pods, or arrange the pods, based on a state of a resource remaining on the nodes after the pods are arranged.

The plurality of first to third nodes 170a to 170c may include at least one pod. The pod may include at least one container. The plurality of first to third nodes 170a to 170c may transmit information about the node to the control plane 110. The information about the node may include, but is not limited to, a UUID of the node, an available resource of the node, a current resource state, and information about the managed pod. The plurality of first to third nodes 170a to 170c may receive information about another node from the control plane 110.

Depending on types of the plurality of first to third nodes 170a to 170c, a network connection state, a resource state, a battery state, or the like may be different. For example, from among the plurality of first to third nodes 170a to 170c, there may be a node with stable battery, resource, and network connection. There may be nodes with an unstable network connection and/or an insufficient battery capacity or resources. When a node is a mobile node, connection to a network may be unstable. For example, in the case of a mobile node, depending on movement of a user, a type of network to which the node is connected may change and/or the connection may be lost, and as a result, connection with other nodes within the cluster may be unstable. Thus, there is a need for a management method for a node that may not be capable of performing an operation stably within a cluster (e.g., when a resource of the node is limited or there is a battery problem). When data is managed through an owned management server (e.g., on-premise) rather than using a public cloud, more efficient and variable resources may need to be utilized. Hereinafter, a method of managing at least one node by using a virtual node 10 is described.

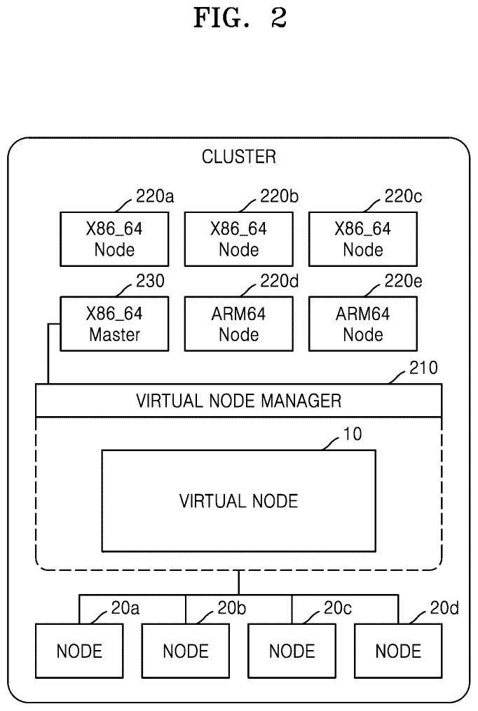

FIG. 2 is a diagram for explaining a node management method through a virtual node 10, according to an embodiment of the present disclosure.

Referring to FIG. 2, a cluster may include a plurality of nodes (e.g., a first node 220a, a second node 220b, a third node 220c, a fourth node 220d, and a fifth 220e) and at least one master node 230 for managing the plurality of nodes. The cluster may also include a virtual node 10 for managing at least one node (e.g., a first node 20a, a second node 20b, a third node 20c, and a fourth node 20d), and a virtual node manager 210 for managing the virtual node 10.

In an embodiment, the plurality of first to fifth nodes 220a to 220e may include different architectures such as, but not limited to, X86, X64, and 64-bit advanced reduced instruction set computer (RISC) machines (ARM) (ARM64). The master node 230 for managing nodes may include a plurality of nodes. The master node 230 may transmit and/or receive a pod and/or data to and/or from the plurality of first to fifth nodes 220a to 220e and the virtual node 10.

In an embodiment, the at least one node 20a to 20d may refer to a node that may not be capable of performing an operation stably within the cluster due to, for example, unstable network connection or lack of battery or resources. In an embodiment, the at least one node 20a to 20d may refer to a mobile node.

In an embodiment, the master node 230 may manage the virtual node 10 at the same level as the plurality of first to fifth nodes 220a to 220e. In an embodiment, the virtual node 10 may include, but is not limited to, a virtual node client, a node manager, or the like. The virtual node client 310 of the virtual node 10 may exchange data with the control plane 330 and/or the master node 230. The virtual node client 310 may be managed by the master node 230. The virtual node client 310 may perform the same function as a node client of the existing node. For example, the virtual node client 310 may transmit, to the master node 230, information about the at least one node 20a to 20d registered in the virtual node 10 and receive, from the master node 230, a pod to be placed in the at least one node 20a to 20d. The node manager of the virtual node 10 may perform an operation related to the at least one node 20a to 20d and exchange data therewith. The node manager may manage a resource of the at least one node 20a to 20d. The node manager may transmit a pod to each node, based on information about the at least one node 20a to 20d.

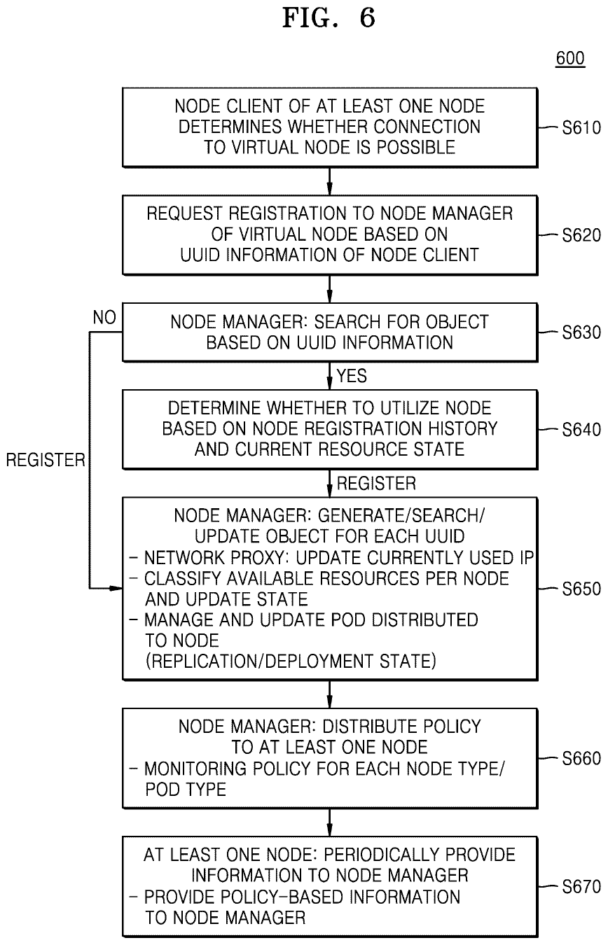

In an embodiment, the at least one node 20a to 20d may obtain information about the virtual node 10 from the master node 230. The at least one node 20a to 20d may perform a registration request, based on the obtained information about the virtual node 10. The virtual node 10 may perform a registration operation, based on information about the at least one node 20a to 20d, which may be provided in the registration request, and/or information about the at least one node 20a to 20d, which may be received separately. The virtual node 10 may perform the registration operation, based on whether there is a registration history of the at least one node 20a to 20d. Hereinafter, a method of performing registration in the virtual node 10 is described with reference to FIG. 6.

In an embodiment, the virtual node 10 may transmit, to the at least one node 20a to 20d in which registration is completed, information for managing a node or a pod to be distributed to the node. Based on the information for managing the node or the pod, the at least one node 20a to 20d may periodically transmit, to the virtual node 10, resource information of the at least one node 20a to 20d or information about an occurring event.

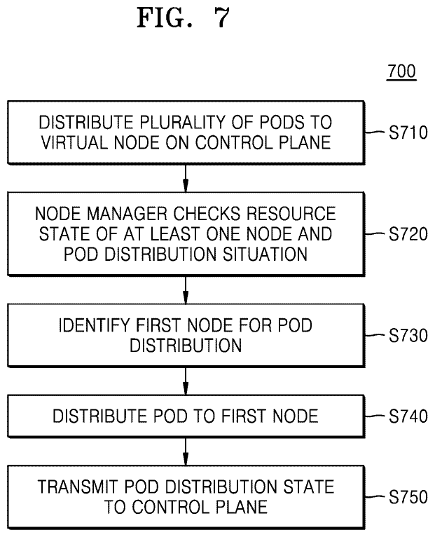

In an embodiment, a node client of the virtual node 10 may receive, from the master node 230, a plurality of pods. The master node 230 may transmit, to the virtual node 10, a plurality of pods, based on resource information of all of the at least one node 20a, 20b, 20c, and 20d registered in the virtual node 10. The node manager of the virtual node 10 may distribute pods, based on the resource information about each of the at least one node 20a, 20b, and 20c. Hereinafter, a method of distributing pods is described with reference to FIG. 7.

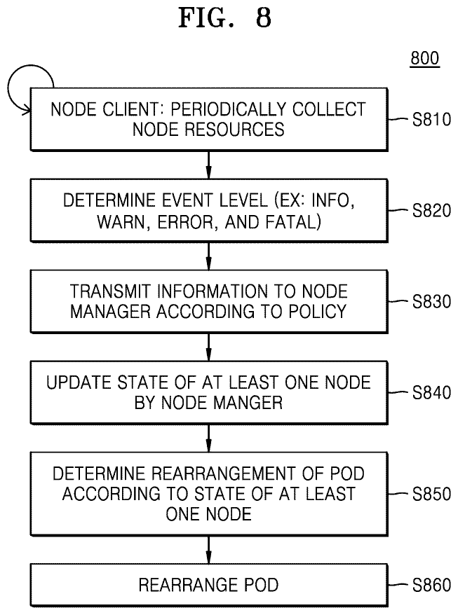

In an embodiment, the virtual node 10 may determine to rearrange pods when an event occurs in the at least one node 20a to 20d. Hereinafter, a method of rearranging pods is described in detail with reference to FIG. 8.

In an embodiment, when performing transmission or rearrangement to the at least one node 20a to 20d, the virtual node 10 may transmit or report, to the master node 230, information related to arrangement of the pods.

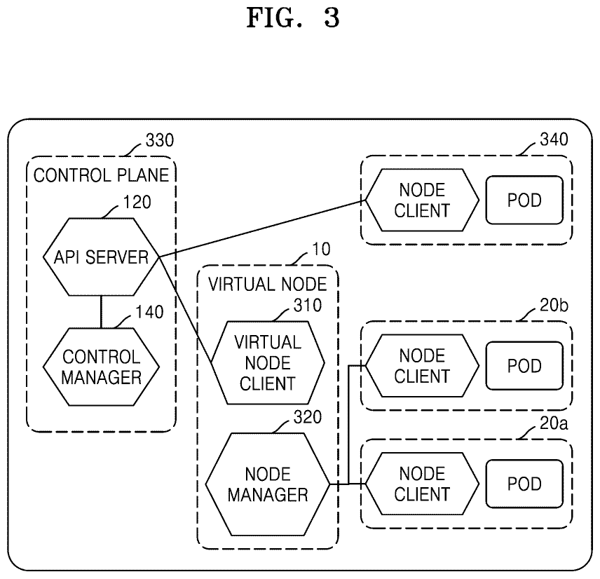

FIG. 3 is a diagram for explaining an operation of a virtual node 10, according to an embodiment of the present disclosure.

Referring to FIG. 3, the virtual node 10 may manage at least one node 20a and 20b between a control plane 330 and the at least one node 20a and 20b. In an embodiment of the present disclosure, the virtual node 10 may be located inside or outside the master node. For example, the master node may include the control plane 330 and the virtual node 10. Alternatively, the master node may include the control plane 330. The virtual node 10 may include, but is not limited to, a virtual node client 310 and a node manager 320.

In an embodiment, the virtual node client 310 may transmit and/or receive data to and/or from an API server 120 of the control plane 330 or receive a pod from the API server 120. The API server 120 of the control plane 330 may serve as a central access point that may monitor each component within the cluster and may allow each component to perform a task. For example, the API server 120 may be connected to an existing node 340 and the virtual node 10 and may control an operation to be performed by each node. The API server 120 may distribute pods, based on a resource state of the existing node 340 and the virtual node 10. The resource of the virtual node 10 may refer to a resource state and/or the sum of available resources of the at least one node 20a and 20b registered in the virtual node 10. The control plane 330 or the API server 120 may treat the existing node 340 and the virtual node 10 as nodes of the same level. In an embodiment of the present disclosure, the control plane 330 may perform an operation, based on the entire information managed by the virtual node 10, rather than information about each of the at least one node 20a and 20b connected to the virtual node 10. For example, the control plane 330 may perform an operation within the cluster, based on resources or information of all of the at least one node 20a and 20b connected to the virtual node 10.

In an embodiment, the at least one node 20a and 20b may receive, from the control plane 330, information about the virtual node 10 for a registration request to the virtual node 10. Based on information about the virtual node 10 (e.g., connection method, connection address, or the like), the at least one node 20a and 20b may identify whether connection to the virtual node 10 may be possible and perform a registration request to the virtual node 10. The virtual node 10 may perform a registration operation, based on information about the at least one node 20a and 20b. The information about the at least one node 20a and 20b may include, but is not limited to, information about a UUID of the at least one node 20a and 20b, model information, available memory, information about a pod managed by the node, a registration history in the virtual node 10, or the like. Hereinafter, the registration operation in the virtual node 10 is described with reference to FIG. 6.

In an embodiment, the virtual node 10 may transmit information for managing a node or a pod to the at least one node 20a and 20b. The virtual node 10 may distribute pods to the at least one node 20a and 20b according to information and may periodically (or aperiodically) receive, from the at least one node 20a and 20b, information about a resource or an event. The virtual node 10 may determine rearrangement of pods within the at least one node 20a and 20b, based on the periodically obtained information and information for managing a node or a pod. Hereinafter, a method of distributing and rearranging pods is described with reference to FIGS. 7 and 8.

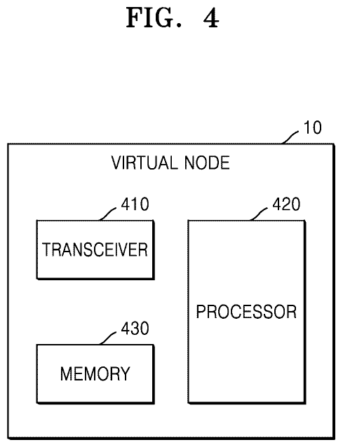

FIG. 4 is a schematic block diagram of a virtual node 10, according to an embodiment of the present disclosure.

Referring to FIG. 4, the virtual node 10, according to an embodiment of the present disclosure, may include a transceiver 410 configured to perform communication with an external node, at least one processor 420 configured to perform at least one instruction, and memory 430 storing the at least one instruction. However, not all of the components shown are required. The virtual node 10 may be implemented by more components than the illustrated components, or the virtual node 10 may be implemented by fewer components.

The transceiver 410 may communicate with external nodes through a wired or wireless network. The external node may include at least one node connected to the master node or the virtual node 10 that manages the nodes.

The transceiver 410, according to an embodiment, may include at least one communication module, such as, but not limited to, a short-range communication module, a wired communication module, a mobile communication module, a broadcast receiving module, or the like. The at least one communication module may include a tuner that may perform broadcast reception, and/or a communication module that may be capable of performing data transmission and/or reception through a network that complies with a communication standard such as, but not limited to, Bluetooth™, wireless local area network (LAN) (WLAN), Wireless-Fidelity (Wi-Fi), wireless broadband (Wibro), world interoperability for microwave access (Wimax), code-division multiple access (CDMA), or wideband CDMA (WCDMA), or the like. The transceiver 410, according to an embodiment of the present disclosure, may receive, from at least one node, information about a UUID, available memory, pod, or registration history. The transceiver 410 may transmit, to the master node, data including resource information and receive a plurality of pods. The transceiver 410 may transmit, to at least one node, a pod or information for managing a node and a pod.

The processor 420 may control the overall operation of the virtual node 10. In an embodiment of the present disclosure, the processor 420 may be implemented with a plurality of processors. For example, the processor 420 may execute the instruction stored in the memory 430 to perform a registration operation in response to a registration request from at least one node by using data received from the transceiver 410. Based on information about at least one node, a plurality of pods received from the master node may be distributed to at least one node. In an embodiment of the present disclosure, the processor 420 may generate and/or update information about at least one node based on information about a registration history of at least one node. The processor 420 may determine whether to rearrange pods, based on information about an event, received from the at least one node.

The memory 430 may store a program command or code executed in the processor 420 and may store input/output data (e.g., information about at least one node, a pod received from a master node, or information about an event). In an embodiment of the present disclosure, the memory 430 may be implemented with a plurality of memories.

The memory 430 may include at least one type of storage medium that may include, but not be limited to, a flash memory type, a hard disk type, a multimedia card micro type, card type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, a magnetic disk, an optical disk, or the like.

In an embodiment, the memory 430 may store data obtained through the transceiver 410. The data may include, but not be limited to, a UUID of at least one node, available memory of at least one node, information about a pod, and information about an event.

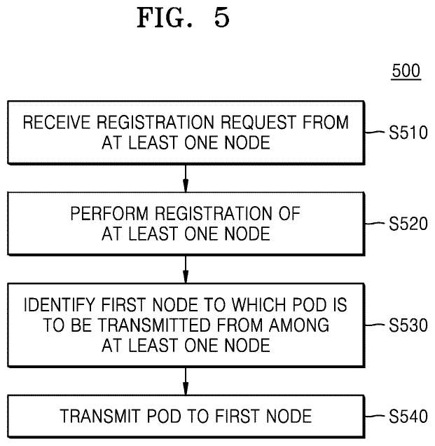

FIG. 5 is a flowchart for explaining a node management method through a virtual node 10, according to an embodiment of the present disclosure.

In operation S510 of the node management method 500, the virtual node 10 may receive a registration request from at least one node 20. In an embodiment of the present disclosure, the virtual node 10 may be located inside the master node or may be located externally, separately from the master node. The master node may include a control plane 110. The at least one node 20 may refer to a node in an unstable state, such as, for example, having unstable network connection or an insufficient battery or storage capacity. In an embodiment of the present disclosure, the at least one node 20 may refer to a mobile node.

In an embodiment, the virtual node 10 may include a virtual node client 310 and a node manager 320. The node client of the virtual node 10 may transmit and/or receive data or a pod to and/or from the control plane 330. The node manager 320 of the virtual node 10 may receive a registration request from the at least one node 20.

In an embodiment, the at least one node 20 may identify whether connection to the virtual node 10 is possible based on information about the virtual node 10. The information of the virtual node 10 may include, but is not limited to, an access method or access address (e.g., IP address) to the virtual node 10. The at least one node 20 may obtain the information about the virtual node 10 from the API server 120 of the control plane 110 to recognize whether there is the virtual node 10 or a connection method to the virtual node 10. In the present disclosure, an API server 120 may be a server that may perform a mechanism that allows nodes to communicate with each other by using a set of definitions and protocols and may refer to an interface provided at a server side to allow a client to request a resource. The API server 120 may manage a cluster network interface (CNI) that represents connection between nodes. Depending on a location or situation in which the at least one node 20 is located, whether there is the virtual node 10 to which a registration request is possible may vary. Accordingly, the at least one node 20 may obtain information about the virtual node 10 from the API server 120 and, based on the obtained information, identify whether registration in the virtual node 10 is possible. When determining that registration in the virtual node 10 is possible, the at least one node 20 may transmit a registration request to the virtual node 10.

In an embodiment, the registration request of the at least one node 20 may include information about the at least one node 20. The information about the at least one node 20 may include, but is not limited to, information about a UUID of the at least one node 20, model information, available memory, information about a pod managed by the at least one node 20, a registration history in the virtual node 10, or the like. In the present disclosure, a UUID may be a universally unique identifier and may refer to an identifier that may be ensured to be unique for each node on a network of a cluster.

In operation S520 of the node management method 500, the virtual node 10 may perform registration of the at least one node 20. In an embodiment of the present disclosure, the virtual node 10 may perform registration of the at least one node 20, based on information about the at least one node 20. The information about the at least one node 20 may be provided in the registration request received in operation S510. Alternatively or additionally, the virtual node 10 may receive the information about the at least one node 20 separately from the registration request.

In an embodiment, the virtual node 10 may identify the information about the at least one node 20, based on a UUID of the at least one node 20. The virtual node 10 may obtain information about the registration history of the at least one node 20 to the virtual node 10, based on the UUID of the at least one node 20.

In an embodiment, the virtual node 10 may perform a registration operation, based on the information about the registration history of the at least one node 20. That is, when the at least one node 20 has a registration history in the virtual node 10, the virtual node 10 may determine whether to use the at least one node 20, based on the registration history and the information about the at least one node 20. For example, the virtual node 10 may obtain information about a purpose for which the at least one node 20 is previously used, information about a managed pod, and information about a function performed within a cluster and a resource state, based on the information about the registration history of the at least one node 20. The virtual node 10 may perform a registration operation when determining that the at least one node 20 is available based on the obtained information. In an embodiment of the present disclosure, the node manager 320 of the virtual node 10 may determine whether the at least one node 20 is utilized and perform a re-registration operation.

In an embodiment, the virtual node 10 may update information about the at least one node 20 when performing a re-registration procedure for the at least one node 20 that has a registration history. The node manager 320 of the virtual node 10 may update information about the at least one node 20. For example, information about an IP of the virtual node 10 that receives a registration request, information about an available resources and current resource state of the at least one node 20, and information about a pod managed and/or to be managed by the at least one node 20 may be updated.

According to an embodiment, when the at least one node 20 does not have a registration history in the virtual node 10, the virtual node 10 may determine whether to perform a registration procedure for the at least one node 20, based on the obtained information about the at least one node 20. When performing a registration procedure for the at least one node 20, the virtual node 10 may generate information about the at least one node 20. The node manager 320 of the virtual node 10 may generate the information about the at least one node 20. For example, information about an IP of the virtual node 10 that receives a registration request, information about an available resources and current resource state of the at least one node 20, and information about a pod managed/to be managed by the at least one node 20 may be generated.

In an embodiment, the virtual node 10 may manage a pod, based on the generated or updated information about the at least one node 20 and/or may perform a re-registration operation when receiving a registration request from the at least one node 20 thereafter.

In an embodiment, the virtual node 10 may transmit information for managing a node or a pod to the at least one node 20 that completes registration. The information for managing a node may include a policy for node management. That is, the policy for node management may include information on a method of transmitting and/or receiving information about an event or a cycle for transmitting and/or receiving information when an event occurs in the at least one node 20. The policy for node management may include a method by which the at least one node 20 may manage a pod. The at least one node 20 may periodically (or aperiodically) transmit, to the virtual node 10, information about a resource state and information about the at least one node 20 according to the policy. The virtual node 10 may determine whether to transmit or rearrange a pod, based on the received information related to the at least one node 20.

In operation S530 of the node management method 500, the virtual node 10 may identify a first node, to which a pod is to be transmitted, from among the at least one node 20. The virtual node 10 may identify the first node, to which the pod is to be transmitted, based on the information about the at least one node 20 from among the at least one node 20 registered in operation S520.

In an embodiment, the virtual node 10 may receive a plurality of pods from a control plane 330. The virtual node 10 may determine a node to which the plurality of pods are to be transmitted, based on the obtained information about the at least one node 20. Depending on a resource state, registration history, usage history, or connection state of a node, or the like, the virtual node 10 may determine a node to which the plurality of pods are to be transmitted. For example, when a node A has a history of managing a pod x, the virtual node 10 may retransmit the pod x to the node A. The virtual node 10 may transmit a plurality of pods to a node B if the node B has sufficient resources.

In an embodiment, a virtual node client 310 of the virtual node 10 may receive a plurality of pods from an API server 120 of the control plane 330. The API server 120 may transmit a pod to the virtual node 10, based on resource information of all of the at least one node 20 registered in the virtual node 10. For example, the API server 120 may transmit a pod, based on the information about all of the at least one node 20 registered in the virtual node 10, rather than information about each of the at least one node 20.

The node manager 320 of the virtual node 10 may determine a node to which the plurality of pods are to be transmitted, based on information about the registered at least one node 20. For example, when connection to the at least one node 20 is unstable, a pod may not be transmitted to the corresponding node. When there is a pod managed by the at least one node 20 and resources for managing additional pods are not sufficient, the virtual node 10 may not transmit the pod to the corresponding node.

In operation S540 of the node management method 500, the virtual node 10 may transmit a pod to the first node. The virtual node 10 may transmit the pod to the first node identified in operation S530.

In an embodiment, the virtual node 10 may transmit the pod to the first node from among at least one node, based on information or a policy for managing the at least one node 20.

In an embodiment, the virtual node 10 may receive information about an event from the at least one node 20 when an event occurs in the at least one node 20, based on information or a policy for managing the node. The event may include a log level. For example, the event may include an informational message (info) such as state changes, a warning message (warn) indicating that there is no problem with execution itself but that an error may be caused in the future, a state message (error) indicating that a problem occurs during processing of a request, and/or a state message (fatal) indicating that a serious error occurs.

The policy may include a method by which the at least one node 20 transmits a message to the virtual node 10 depending on the type of event. For example, in the case of the informational message, the informational message is not an urgent message, and thus the at least one node 20 may transmit a related message to the virtual node 10 at a time according to a determined cycle. In the case of the state message indicating that a serious error occurred, it may be necessary to notify the virtual node 10 immediately upon occurrence of the error, and thus the at least one node 20 may transmit the message to the virtual node 10 immediately upon occurrence of the serious error.

In an embodiment, the virtual node 10 that receives information about an event may determine to rearrange pods within the at least one node 20. For example, when receiving an error message from the node A, the virtual node 10 may determine rearrange, in the node B, pods managed by the node A in consideration of a network connection state, a resource state, or the like.

FIG. 6 is a flowchart for explaining a method for registration to a virtual node 10, according to an embodiment of the present disclosure.

Referring to FIG. 6, the method 600 may include operations that may include and/or may be similar in many respects to operations described with reference to FIG. 5. Consequently, repeated descriptions of the operations of the method 600 described above with reference to FIG. 5 may be omitted for the sake of brevity.

As described with reference to FIGS. 1 to 4, the virtual node 10 may include a virtual node client 310 and a node manager 320. The at least one node 20 may include a node client.

In operation S610 of the method 600, the node client of the at least one node 20 may determine whether connection to the virtual node 10 is possible. The at least one node 20 may determine whether connection to the virtual node 10 is possible based on the obtained information of the virtual node 10.

In an embodiment, the at least one node 20 may obtain information about the virtual node 10 from an API server 120 of a control plane 110. The information about the virtual node 10 may include, but is not limited to, information about a connection method to the virtual node 10, a connection address, or coverage of the virtual node 10. The API server 120 may be and/or may include an interface provided at a server side to allow a client to request a resource and may perform a function of monitoring elements present within a cluster and performing a task. The at least one node 20 may determine whether connection to the virtual node 10 is possible based on the obtained information. For example, the at least one node 20 may determine that connection to the virtual node 10 is not possible when a node is not provided within coverage of the virtual node 10.

In operation S620, the node client of the at least one node 20 may request registration to the node manager 320 of the virtual node 10 by using universally unique identifier (UUID) information. The UUID information may refer to a standard protocol for ensuring the uniqueness of an identifier (ID) that may be issued by a separate system in a distributed environment. Each of the at least one node 20 may make a registration request to the virtual node 10 by using a unique UUID. The registration request of the at least one node 20 may include information about the unique UUID.

In an embodiment, when determining that connection to the virtual node 10 is possible in operation S610, the at least one node 20 may transmit the registration request to the node manager 320 of the virtual node 10. A registration request message may include information about the at least one node 20. The information about the at least one node 20 may include, but is not limited to, information about a UUID of the at least one node 20, model information, available memory, information about a pod managed by the at least one node 20, and a registration history in the virtual node 10.

In operation S630, the node manager 320 of the virtual node 10 may search for an object by using UUID information of the at least one node 20. The virtual node 10 may perform a search for the at least one node 20, based on information provided in the registration request message of the at least one node 20.

In an embodiment, the virtual node 10 may retrieve a registration history of the at least one node 20, based on the UUID information. When there is a registration history in the virtual node 10 in the at least one node 20, the virtual node 10 may obtain information about a purpose of use of the at least one node 20, resource information, or information about a pod managed by the at least one node 20.

The virtual node 10 may perform operation S640 when there is a registration history of the at least one node 20 (YES at operation S630) and may perform operation S650 when there is no registration history (NO at operation S630).

In operation S640, the node manager 320 of the virtual node 10 may determine whether to utilize the at least one node 20, based on the registration history and current resource state of the at least one node 20.

According to an embodiment, when the at least one node 20 has a registration history in the virtual node 10, the virtual node 10 may determine whether to utilize the at least one node 20, based on stored information about the at least one node 20. The information about the at least one node 20 may include, but is not limited to, information about a purpose of use of the at least one node 20, a past or present resource state, and a pod that is currently managed/previously managed at a time of transfer registration to the virtual node 10.

When the at least one node 20 has no registration history in the virtual node 10, the virtual node 10 may determine whether to utilize the at least one node 20, based on the current resource state of the at least one node 20.

In operation S650, the node manager 320 of the virtual node 10 may generate, search for, and update an object for each UUID. The virtual node 10 may update information about the at least one node 20 when the at least one node 20 has a registration history in the virtual node 10 as a search result based on the UUID. The virtual node 10 may generate information about the at least one node 20 when the at least one node 20 has no registration history as a search result based on the UUID.

In an embodiment, the information about the at least one node 20 may include information about a current connection IP, an available resource and resource state, information about a pod managed/to be managed by a node, or the like. For example, the node manager 320 may generate and/or update an IP of a network proxy to which the at least one node 20 is connected. The node manager 320 may classify available resources per node and generate and/or update information about the current resource state. As another example, in the case of a mobile node, available resources may be different for respective mobile models, and thus the node manager 320 may classify available resources for the respective models and update and store and/or generate information about the resource state of the node in consideration of a pod currently managed by the mobile node.

The node manager 320 may update information for managing pods distributed to the at least one node 20. Information for managing a pod may include, but is not limited to, information about the number of containers provided in the pod, a function of the pod, and arrangement of pods, or information about whether the pod is replicated, a resource required by the pod, or the like. For example, the node manager 320 may arrange a pod x and a pod y on a node A and a pod z on a node B, based on the information about the at least one node 20. The node manager 320 may update information about an arrangement state of pods after the pods are arranged on nodes for each pod.

In operation S660, the node manager 320 may distribute policies to the at least one node 20 that completes registration. The node manager 320 may distribute, to each of the at least one node 20, a policy including information for managing a node and/or pods arranged on nodes.

In an embodiment, the policy may include, but not be limited to, information about a monitoring method for each node type or each pod type. For example, the information for managing a node and/or a pod may include, but not be limited to, information about a method of transmitting and/or receiving the corresponding information for each event, or a cycle for transmitting and/or receiving the corresponding information, when an event occurs in the node.

In detail, the event may include a log level. For example, the event may include an informational message (info) indicating state changes, a warning message (warn) indicating that there is no problem with the current execution itself but that an error may be caused in the future, a state message (error) indicating that a problem occurs during processing of a request, a state message (fatal) indicating that a serious error occurs, or the like. Depending on the type of event, in the case of informational message, the informational message may not be an urgent message, and thus may be transmitted to the virtual node 10 according to a determined cycle. The message indicating that a serious error has occurred may need to be transmitted to the virtual node 10 immediately upon occurrence of the error.

In operation S670, the at least one node 20 may periodically (or aperiodically) provide information to the node manager 320. Alternatively or additionally, the at least one node 20 may provide the information to the node manager 320 aperiodically (e.g., on demand, based on the event, or the like). The at least one node 20 may transmit, to the node manager 320 of the virtual node 10, information about an event and/or the at least one node 20, according to the policy received in operation S660.

In an embodiment, the virtual node 10 may identify the resource state and/or connection state to a network of the at least one node 20, based on the information about the at least one node 20, which may be obtained periodically (or aperiodically). The virtual node 10 may determine whether to rearrange pods within the at least one node 20, based on the periodically (or aperiodically) received information. An operation related to rearrangement of pods is described with reference to FIG. 8.

FIG. 7 is a flowchart for explaining a distribution procedure of a pod, according to an embodiment of the present disclosure.

Referring to FIG. 7, in operation S710 of the method 700, a control plane 110 may distribute a plurality of pods to a virtual node 10. As shown in FIG. 1, the control plane 110 may include, but is not limited to, an API server 120, a control manager 140, a cloud control manager 130, memory 150, and a scheduler 160.

In an embodiment, the scheduler 160 of the control plane 110 may distribute pods in consideration of a resource state of the virtual node 10. For example, the control plane 110 may distribute the pods, based on the resource state of all of the at least one node 20 registered in the virtual node 10, rather than resource information for each of the at least one node 20 registered in the virtual node 10. That is, the scheduler 160 may distribute the pods in consideration of available resources of the virtual node 10 or in consideration of resources of the virtual node 10, which may remain after the pods are distributed.

In an embodiment, when the scheduler 160 of the control plane 110 distributes a plurality of pods to the virtual node 10, the API server 120 may update information about an arrangement state of the pods in the memory 150.

In operation S720, the node manager 320 of the virtual node 10 may check the current resource state and pod distribution situation of the at least one node 20. The node manager 320 may check the resource state and pod distribution situation by using a UUID of the registered at least one node 20.

In an embodiment, when performing the registration operation of the at least one node 20, the node manager may update or generate information about the current resource state, available resource, IP address of a connected network, and managed pod for each unique UUID of the at least one node 20. The node manager 320 may check the resource state and current pod distribution situation of the at least one node 20, based on information about the at least one node 20, which may be updated and/or generated.

In operation S730, the node manager 320 of the virtual node 10 may identify a first node for distributing pods. The node manager 320 may identify the first node to which the pod is to be transmitted, based on the current resource state and pod distribution situation from among the at least one node 20.

In an embodiment, the virtual node 10 may identify the first node to which each of the plurality of pods received from the control plane 110 is to be transmitted. The virtual node 10 may determine whether to distribute pods in consideration of a usage role, available memory, network connection state, or the like of the at least one node 20, based on the information about the at least one node 20, which is generated or updated.

In operation S740, the node manager 320 of the virtual node 10 may distribute pods to the identified first node. The virtual node 10 may transmit the pod to the first node identified in operation S730.

In an embodiment, the virtual node 10 may distribute, to the at least one node 20, the plurality of pods received from the control plane 110 in a distributed manner. The virtual node 10 may manage the pods, based on information or a policy for managing nodes and pods, transmitted in the registration operation of the at least one node 20.

In operation S750, the virtual node 10 may transmit, to the control plane 330, information about a pod distribution state. The virtual node client 310 of the virtual node 10 may transmit information about the pod distribution state to the API server 120 of the control plane 110 when the plurality of pods are distributed to at least one node registered in the virtual node 10.

In an embodiment, the API server 120 of the control plane 110 may transmit the received information about the pod distribution state to the memory 150 (or a distributed data storage (e.g., Linux etcd®)) and store the information. The information about the pod distribution state may include, but may not be limited to, information about whether each of a plurality of pods is distributed, and information about an available resource after pod distribution.

In an embodiment, the control plane 110 may determine whether to additionally transmit a pod to the virtual node 10, based on the received information about the pod distribution state. When rearranging pods in the at least one node 20, the virtual node 10 may transmit information about the pod distribution state to the control plane 330.

FIG. 8 is a diagram for explaining a rearrangement procedure of a pod, according to an embodiment of the present disclosure.

Referring to FIG. 8, in operation S810 of the method 800, the node client of the at least one node 20 may periodically collect node resources. The at least one node 20 may monitor operations, based on the received pod, and may obtain information about the node resources.

In an embodiment, available memory may vary depending on a node type of the at least one node 20. The at least one node 20 may periodically (or periodically) update information about a resource used in response to the operation based on the pod received from the virtual node 10, based on an available resource.

In an embodiment, the node resource may include, but may not be limited to, information about the amount of resources used when an operation is performed, a frequency of performing the operation, or an event that occurs when the operation is performed. The information about the event may include, but not limited to, an informational message (info) such as a change in the state of a node, a warning message (warn) indicating that an error may occur in the future, a state message (error) indicating that an error occurs during performance of an operation, and a state message (fatal) indicating that a serious error occurs.

In an embodiment, the node client of the at least one node 20 may periodically (or aperiodically) obtain the node resource according to a determined cycle. The cycle for obtaining resources may be determined according to information for managing a node and a pod, which may be received from the virtual node 10. Alternatively or additionally, the node client of the at least one node 20 may obtain the node resource aperiodically (e.g., on demand, based on an interrupt signal, or the like). For example, a node A, which receives a pod x related to driving of a high-priority application, may obtain information at short intervals, and a node B, which receives a pod y related to driving of a secondary application, may obtain information about the node resource at longer intervals than the node A.

In operation S820, the node client may determine a level of an event. The level may vary, depending on the event that occurs in operation S810.

For example the informational message indicating a state change is not a critical event for an operation of a node, and therefore has a relatively low event level. In contrast, the message indicating that an error occurs or the message indicating that a serious error occurs may have a relatively high event level because an operation of a pod distributed to the corresponding node may not be performed.

In operation S830, the node client may transmit information to the node manager 320 of the virtual node 10 according to a preconfigured policy. The node client may transmit, to the virtual node 10, information about an event that occurs in the at least one node 20 or about the node resource, based on information for managing a node and a pod.

In an embodiment, the node client may transmit information to the node manager 320 immediately or periodically based on the event level determined in operation S820. For example, the informational message may be transmitted to the node manager 320 at a preconfigured cycle depending on the event level. The message related to the error may be transmitted to the node manager 320 subsequent to the corresponding message being obtained.

In operation S840, the node manager 320 may update a state of the at least one node 20. The node manager 320 may update information about the state of the at least one node 20, based on the information obtained in operation S830.

In an embodiment, the virtual node 10 may update the information about the changed state of the at least one node 20, based on information stored for the UUID of the at least one node 20. For example, when receiving information indicating that the available memory of the node A from among the at least one node 20 registered in the virtual node 10 is sufficient, the virtual node 10 may update the resource state for the node A. When receiving information indicating that a network connection state of the node B is unstable, the virtual node 10 may update information about the state of the node B.

In operation S850, the virtual node 10 may determine rearrangement of pods, based on the state of the at least one node 20. The virtual node 10 may determine whether to rearrange pods within the at least one node 20, based on the state information of the at least one node 20, updated in operation S840.

In an embodiment, the virtual node 10 may determine whether to rearrange pods, based on the resource state, network connection state, or battery state of the at least one node 20, or the like. For example, the virtual node 10 may determine to rearrange the pod y arranged on the node B when the network connection state of the node B is unstable. When the information indicating that the node A has sufficient resources is updated, the virtual node 10 may additionally distribute the pod y to the node A.

In operation S860, the virtual node 10 may perform rearrangement of pods. When performing the rearrangement of pods, the virtual node 10 may transmit information about the rearrangement of pods to the API server 120 of the control plane 330. If the available memory of all of the at least one node 20 connected to the virtual node 10 changes as a rearrangement result of pods, the virtual node 10 may transmit information about the available memory to the API server 120.

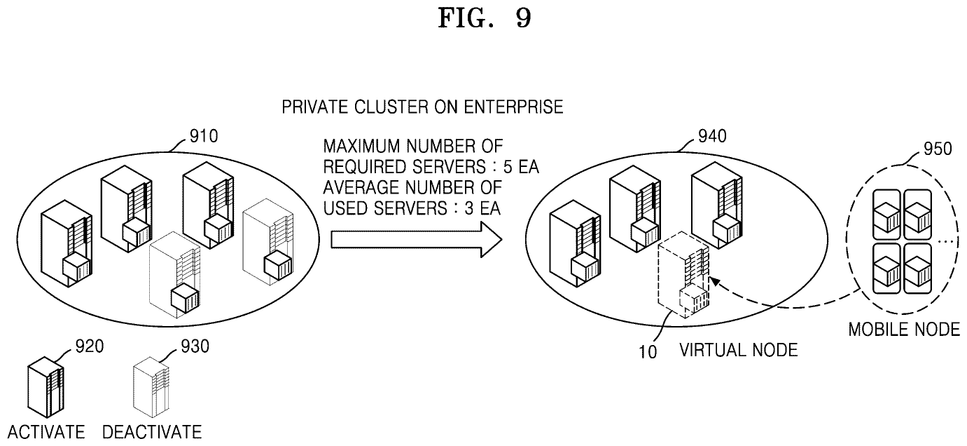

FIG. 9 is a diagram for explaining an example of a node management method through a virtual node 10, according to an embodiment of the present disclosure.

Referring to FIG. 9, a resource may be used through the node management method by using a virtual node 10 in, for example, a company or a factory. In the case of a company or a factory, a private data center (e.g., an on-premise data center) may be owned and/or maintained in an own facility. For example, the company may process data as business information while ensuring high security through an on-premise system. However, implementation and/or upkeep of the system may be time and/or cost prohibitive, and thus, it may be necessary to plan resources in advance and process the data.

In the case of an existing method 910, the maximum number of servers required to process data within a private cluster may be, for example, five (5), and an average number of servers used may be, for example, three (3). That is, when the system is established to include five (5) servers to satisfy the maximum number of servers required, only three (3) servers may be activated (920) on average, and thus, two (2) servers may not be activated (930), which may result in a waste of resources.

Therefore, in the case of an embodiment of the present disclosure (940), the number of servers used on average (e.g., three (3)) may be maintained for stability of the system and fast processing of data, but a work processed by two (2) servers may be replaced through a mobile node 950. For example, information needed for a work may be processed by the mobile node 950, and information may be processed and/or selected according to a high-importance event and/or a preconfigured cycle, and may be transmitted to the virtual node 10.

In the case of the mobile node 950, connection to a network may be unstable depending on the mobility of a user, the amount of available resources may be low, and stable connection within a cluster may not be ensured due to a battery capacity issue, and as a result, an operation may be performed using the virtual node 10, according to an embodiment of the present disclosure. In the present disclosure, the mobile node 950 may refer to a node with a relatively low stability.

In an embodiment, the virtual node 10 may receive a registration request from the mobile node 950 and register the mobile node 950. The virtual node 10 may obtain and update the UUID, available memory, information about a pod, information about a registration history in the virtual node 10, or the like of the mobile node 950 through the registration procedure. The virtual node 10 may distribute and manage pods for performing an operation within a cluster, based on information about the mobile node 950. The virtual node 10 may periodically (or aperiodically) receive the information about the mobile node 950 and may determine whether to rearrange the pods, based on the received information.

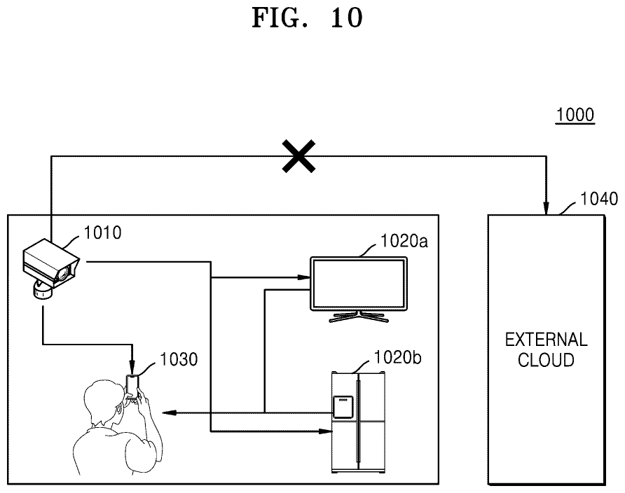

FIG. 10 is a diagram for explaining an example of a node management method through a virtual node 10, according to an embodiment of the present disclosure.

Referring to FIG. 10, a method 1000 of processing data without exchanging information with an external cloud 1040 by using Internet of Things (IoT) home appliances (e.g., a television 1020a and a refrigerator 1020b) or a mobile node 1030 is illustrated. Although FIG. 10 depicts the IoT home appliances as being a television and a refrigerator, the present disclosure is not limited in this regard. For example, the IoT home appliances may be and/or may include various home appliances and/or devices without departing from the scope of the present disclosure.

As the use of a closed-circuit television (CCTV) 1010 in homes increases, the method 1000 of using a virtual node 10, according to an embodiment of the present disclosure, may be proposed as a method of independently managing private data, such as, but not limited to, CCTV footage, without transmitting the data to the external cloud 1040.

In the case of footage of the CCTV 1010, as filming may be conducted for 24 hours a day and/or a determined period of time, video data may accumulate, and thus a relatively large amount of data may be generated, which may be difficult to process without using the external cloud 1040. In an example, data on images from the CCTV 1010 may be stored and the stored data may be transmitted to the mobile node 1030 by using the IoT home appliances (e.g., the television 1020a or the refrigerator 1020b), and thus the data may be processed by the corresponding mobile node 1030 during a time during which a user may not use the mobile node 1030. In the case of the mobile node 1030, the stability of the node may not be ensured due to mobility within the home or access to the outside, and accordingly, a virtual node 10 may be used.

For example, the virtual node 10 may receive a registration request from the mobile node 1030 of the user and perform a registration operation. The mobile node 1030 registered in the virtual node 10 may transmit information about a resource state of the mobile node to the virtual node 10 at a determined cycle. When receiving information indicating that there are sufficient available resources from the mobile node 1030 of the user, the virtual node 10 may transmit, to the mobile node 1030, image data stored in the IoT home appliances (e.g., the television 1020a or the refrigerator 1020b), or the like. The mobile node 1030 may determine whether a special event occurs in the image data. The mobile node 1030 may transmit data obtained as a determination result to the virtual node 10, and the virtual node 10 may transmit the obtained data to a server to perform processing on the data.

In a method of performing communication by the virtual node 10, according to an embodiment of the present disclosure, a registration request may be received from at least one node from among a plurality of nodes. In the method of performing communication by the virtual node 10, at least one registration may be performed based on information related to at least one node. In the method of performing communication by the virtual node 10, a first node to which a pod is to be transmitted may be identified from among the at least one node and the pod may be transmitted to the first node, based on the information related to the at least one node. The pod may be received from the control plane 110 that controls the plurality of nodes and the virtual node 10.

In the method of performing communication by the virtual node 10, according to an embodiment of the present disclosure, a registration history of at least one node may be identified based on the information related to the at least one node. If there is a registration history of at least one node, whether to re-register the at least one node may be determined based on the information related to the at least one node and the registration history. The information related to the at least one node may be updated. If there is no registration history of at least one node, whether to register the at least one node may be determined based on the information related to the at least one node. The information related to the at least one node may be generated.

In the method of performing communication by the virtual node 10, according to an embodiment of the present disclosure, information for managing at least one node may be transmitted to the at least one node. In the method, the information related to the at least one node may be received from the at least one node at a preconfigured cycle, based on the information for managing the at least one node.

In the method of performing communication by the virtual node 10, according to an embodiment of the present disclosure, in case that an event occurs in at least one node, information related to the event may be received from the at least one node. In the method, a state of the at least one node may be updated based on the information related to the event, and whether to rearrange pods managed by the at least one node may be determined based on the state of the at least one node.

In the method of performing communication by the virtual node 10, according to an embodiment of the present disclosure, a second node for rearranging pods managed by at least one node may be identified based on the state of the at least one node in case that rearrangement of the pods is determined based on the state of the at least one node. In the method, a pod may be transmitted to the second node.

In the method of performing communication by the virtual node 10, according to an embodiment of the present disclosure, a cycle for receiving the information related to the event may be configured depending on a type of the event. In the method, the information related to the event may be received based on the configured cycle.

In the method of performing communication by the virtual node 10, according to an embodiment of the present disclosure, a registration request may be transmitted based on a result of at least one node identifying whether connection to the virtual node 10 is possible based on the information related to the virtual node 10.

In the method of performing communication by the virtual node 10, according to an embodiment of the present disclosure, the information related to the at least one node may include at least one of a UUID of the at least one node, model information of the at least one node, available memory of the at least one node, pod information managed by the at least one node, or a registration history for the virtual node 10.

In the method of performing communication by the virtual node 10, according to an embodiment of the present disclosure, information related to arrangement of pods may be transmitted to the control plane 330.

In the method of performing communication by the virtual node 10, according to an embodiment of the present disclosure, the at least one node may mean a mobile node.

In the method of performing communication by the virtual node 10, according to an embodiment of the present disclosure, the information related to the virtual node 10 may be obtained from a control plane 110 that controls a plurality of nodes including the node. In the method, a registration request including information related to the node may be transmitted to the virtual node 10, based on the information about the virtual node 10. In the method, at least one pod may be received from the virtual node 10, based on registration information generated in response to the registration request. The at least one pod may be received from the control plane 330.

In the method of performing communication by the virtual node 10, according to an embodiment of the present disclosure, registration information may be obtained based on the information related to the node and the registration history when there is a registration history for a virtual node 10, based on the information related to the node. When there is no registration history for the virtual node 10, the registration information may be obtained based on the information related to the node.

In the method of performing communication by a node, according to an embodiment of the present disclosure, information for managing the node may be received from the virtual node 10. In the method, the information about the node may be transmitted to the virtual node 10 at a preconfigured cycle, based on the information for managing the node.

In the method of performing communication by the virtual node 10, according to an embodiment of the present disclosure, when an event occurs, the information related to the event may be transmitted to the virtual node 10. In the method, information related to rearrangement of pods managed by a node may be received from the virtual node 10, based on the information related to the event.

In the method of performing communication by the virtual node 10, according to an embodiment of the present disclosure, a registration request may be transmitted based on a result of identifying whether connection to a virtual node 10 is possible based on information related to the virtual node 10.

A virtual node 10 for performing communication, according to an embodiment of the present disclosure, may include a transceiver 410, memory 430 storing one or more instructions, and at least one processor 420 configured to execute the one or more instructions. The at least one processor 420 may receive the registration request from at least one node of a plurality of nodes. The at least one processor 420 may perform registration of the at least one node, based on information related to the at least one node. The at least one processor 420 may identify a first node to which a pod is to be transmitted from among the at least one node and transmit the pod to the first node, based on the information related to the at least one node. The pod may be received from the control plane 110 that controls the plurality of nodes and the virtual node 10.

A device-readable storage medium may be provided in the form of a non-transitory storage medium. As used herein, the term non-transitory storage medium refers to a tangible device that does not contain signals (e.g. electromagnetic waves), and the term does not distinguish between cases in which data is stored semi-permanently or temporarily on a storage medium. For example, the non-transitory storage medium may include a buffer in which data is temporarily stored.

According to an embodiment, methods, according to various embodiments disclosed in the present disclosure, may be provided as included in a computer program product. The computer program product may be traded between sellers and buyers as commodities. The computer program product may be distributed in the form of a machine-readable storage medium (e.g., a compact disc read only memory (CD-ROM)), or may be distributed online (e.g., download or upload) via an application store or directly between two user devices (e.g., smartphones). In the case of online distribution, at least a portion of the computer program product (e.g., a downloadable application) may be temporarily stored or temporarily generated in a device-readable storage medium, such as memory of a server of a manufacturer, a server of an application store, or an intermediary server.

While this invention has been described with reference to illustrative embodiments, this description is not intended to be construed in a limiting sense. Various modifications and combinations of the illustrative embodiments, as well as other embodiments of the invention, may be apparent to persons skilled in the art upon reference to the description. It is therefore intended that the appended claims encompass any such modifications or embodiments.

What is claimed is:

1. A method of performing communication by a virtual node, the method comprising:
receiving a registration request from at least one node of a plurality of nodes;
performing registration of the at least one node, based on information related to the at least one node;
identifying a first node from among the at least one node to which a pod received from a control plane is to be transmitted, based on the information related to the at least one node; and
transmitting the pod to the first node,
wherein the plurality of nodes and the virtual node are controlled by the control plane.

2. The method of claim 1, wherein the performing registration of the at least one node comprises:
identifying a registration history of the at least one node, based on the information related to the at least one node; and
based on identifying the registration history of the at least one node, determining whether to re-register the at least one node and updating the information related to the at least one node.

3. The method of claim 1, wherein the performing registration of the at least one node comprises:
identifying a registration history of the at least one node, based on the information related to the at least one node; and
based on failing to identify the registration history of the at least one node, determining whether to register the at least one node and generating the information related to the at least one node.

4. The method of claim 1, further comprising:
transmitting, to the at least one node, information for managing the at least one node; and
receiving, from the at least one node, the information related to the at least one node at a configured cycle, based on the transmitting of the information for managing the at least one node.

5. The method of claim 1, further comprising:
based on an event occurring in the at least one node, receiving, from the at least one node, information related to the event;
based on the information related to the event, updating a state of the at least one node;
based on the state of the at least one node, determining whether to rearrange the pod managed by the at least one node;
based on determining to rearrange the pod, identifying a second node from among the at least one node for rearranging the pod; and
transmitting the pod to the second node.

6. The method of claim 5, wherein the receiving of the information related to the event comprises:
configuring a cycle for receiving the information related to the event based on a type of the event; and
based on the configured cycle, receiving the information related to the event.

7. The method of claim 1, wherein the receiving of the registration request comprises:
receiving the registration request from the at least one node based on a determination, based on information related to the virtual node, that the at least one node is capable of being coupled with the virtual node.

8. The method of claim 1, wherein the information related to the at least one node comprises at least one of a universally unique identifier (UUID) of the at least one node, model information of the at least one node, available memory of the at least one node, information related to the pod managed by the at least one node, or a registration history for the virtual node.

9. The method of claim 1, further comprising:
transmitting, to the control plane, information related to an arrangement of the pod.

10. A method of performing communication by a node, the method comprising:
obtaining, from a control plane, information related to a virtual node, the control plane controlling the virtual node and a plurality of nodes comprising the node;
transmitting, to the virtual node, a registration request comprising information related to the node, based on the information related to the virtual node; and
receiving, from the virtual node, at least one pod, based on registration information generated based on the registration request, the at least one pod indicating at least one distributable computing unit of a task to be completed.

11. The method of claim 10, wherein the receiving of the at least one pod comprises:
identifying a registration history of the virtual node, based on the information related to the node; and
based on identifying the registration history for the virtual node, obtaining the registration information based on the information related to the node and the registration history.

12. The method of claim 10, wherein the receiving of the at least one pod comprises:
identifying a registration history of the virtual node, based on the information related to the node; and
based on failing to identify the registration history for the virtual node, obtaining the registration information based on the information related to the node.

13. The method of claim 10, further comprising:
receiving, from the virtual node, information for managing the node; and
transmitting, to the virtual node, the information related to the node at a configured cycle, based on the information for managing the node.

14. The method of claim 10, further comprising:
based on an event occurring, transmitting, to the virtual node, information related to the event; and
based on the information related to the event, receiving, from the virtual node, information related to rearrangement of the pod managed by the node.

15. The method of claim 10, wherein the transmitting of the registration request comprises:
transmitting the registration request, based on a result of determining that a connection to the virtual node is enabled, the determining being based on the information related to the node.

16. The method of any one of claim 10, wherein the information related to the node comprises at least one of a universally unique identifier (UUID) of the node, model information of the node, available memory of the node, information of the pod managed by the node, or a registration history for the virtual node.

17. A virtual node for performing communication, the virtual node comprising:
a transceiver;
one or more processors comprising processing circuitry; and
memory storing one or more instructions,
wherein the one or more instructions, when executed by the one or more processors individually or collectively, cause the virtual node to:
receive a registration request from at least one node of a plurality of nodes;
perform registration of the at least one node, based on information related to the at least one node;
identify a first node from among the at least one node to which a pod received from a control plane is to be transmitted, based on the information related to the at least one node; and
transmit the pod to the first node,
wherein the plurality of nodes and the virtual node are controlled by the control plane.

18. The virtual node of claim 17, wherein the one or more instructions, when executed by the one or more processors individually or collectively, further cause the virtual node to:
identify a registration history of the at least one node, based on the information related to the at least one node;
based on identification of the registration history of the at least one node, determine whether to re-register the at least one node and update the information related to the at least one node; and
based on failure to identify the registration history of the at least one node, determine whether to register the at least one node and generate the information related to the at least one node.

19. The virtual node of claim 17, wherein the one or more instructions, when executed by the one or more processors individually or collectively, further cause the virtual node to:
based on an event occurring in the at least one node, receive, from the at least one node, information related to the event;
based on the information related to the event, update a state of the at least one node;
based on the state of the at least one node, determine whether to rearrange the pod managed by the at least one node;
based on a determination to rearrange the pod, identify a second node from among the at least one node for rearranging the pod; and
transmit the pod to the second node.

20. The virtual node of claim 19, wherein the one or more instructions, when executed by the one or more processors individually or collectively, further cause the virtual node to:
configuring a cycle for receiving the information related to the event based on a type of the event; and
based on the configured cycle, receive the information related to the event.
